(19) United States
(12) Patent Application Publication
(10) Pub. No.: US 2006/0004917 A1
(43) Pub. Date: Jan. 5, 2006

(54) Attribute grouping for management of a wireless network

(76) Inventors: Winston Leonard Wang, Hillsborough Place, CA (US); Matthew Chan McCarthy, Hillsborough Place, CA (US)

Correspondence Address: FAY KAPLUN & MARCIN, LLP, 15O BROADWAY, SUITE 702, NEW YORK, NY, 10038, US

(21) Appl. No.: 10/880,857

(22) Filed: Jun. 30, 2004

(51) Int. Cl. G06F 15/173

(52) U.S. Cl. 709/223

(57) ABSTRACT

Described is a method for organizing devices in a wireless network by receiving attributes from a plurality of network devices, the attributes corresponding to information about each of the plurality of devices, storing the received attributes, defining a group of devices, the group definition including one of the received attributes and organizing the devices based on the group definition.

### BACKGROUND INFORMATION

Wireless networks are deployed in a great number of industries such as retail environments, transportation and logistics, manufacturing, warehousing, etc. These wireless networks may include large numbers of mobile units, wireless switches and access points. To maintain these networks routine tasks such as component roll-outs, updates, maintenance, support, etc. need to be performed. However, as the networks grow, the performance of these routine tasks becomes unwieldy. This may become a barrier to growth and result in the underutilization of the wireless network.

### SUMMARY OF THE INVENTION

A method for organizing devices in a wireless network by receiving attributes from a plurality of network devices, the attributes corresponding to information about each of the plurality of devices, storing the received attributes, defining a group of devices, the group definition including one of the received attributes and organizing the devices based on the group definition.

In addition, a system, comprising a receiving element configured to receive attributes from a plurality of network devices, a database configured to store the received attributes, an input element configured to receive a group definition from a user, the group definition including one of the received attributes and an organizational element configured to organize the network devices into a group based on the group definition.

Furthermore, a network appliance comprising a data collection element configured to collect data from a plurality of network devices, the data including attributes corresponding to each of the network devices, a storage element configured to store the collected data, an input element configured to receive a group definition from a user, the group definition including at least one of the attributes and an organizational element configured to organize the collected data based on the group definition.

### BRIEF DESCRIPTION OF THE DRAWINGS

FIG. 1 shows an exemplary network including a wireless network which may implement an exemplary embodiment according to the present invention.

FIG. 2 shows an exemplary mobile unit including a wireless agent according to the present invention.

FIG. 3 shows an exemplary communication path between network devices according to the present invention.

FIG. 4 shows an exemplary system diagram according to the present invention.

FIG. 5 shows a first exemplary user interface display screen displaying attributes according to the present invention.

FIG. 6 shows a second exemplary user interface display screen displaying attributes according to the present invention.

FIG. 7 shows a third exemplary user interface display screen which a system administrator may use to create a group according to the present invention.

FIG. 8 shows an alternate view of the third exemplary user interface display screen which a system administrator may use to create a group according to the present invention.

FIG. 9 shows a fourth exemplary display screen which shows a display for a defined group according to the present invention.

FIG. 10 shows a fifth exemplary display screen which shows a display for a defined group.

FIG. 11 shows an exemplary process for grouping operations according to the present invention.

### DETAILED DESCRIPTION

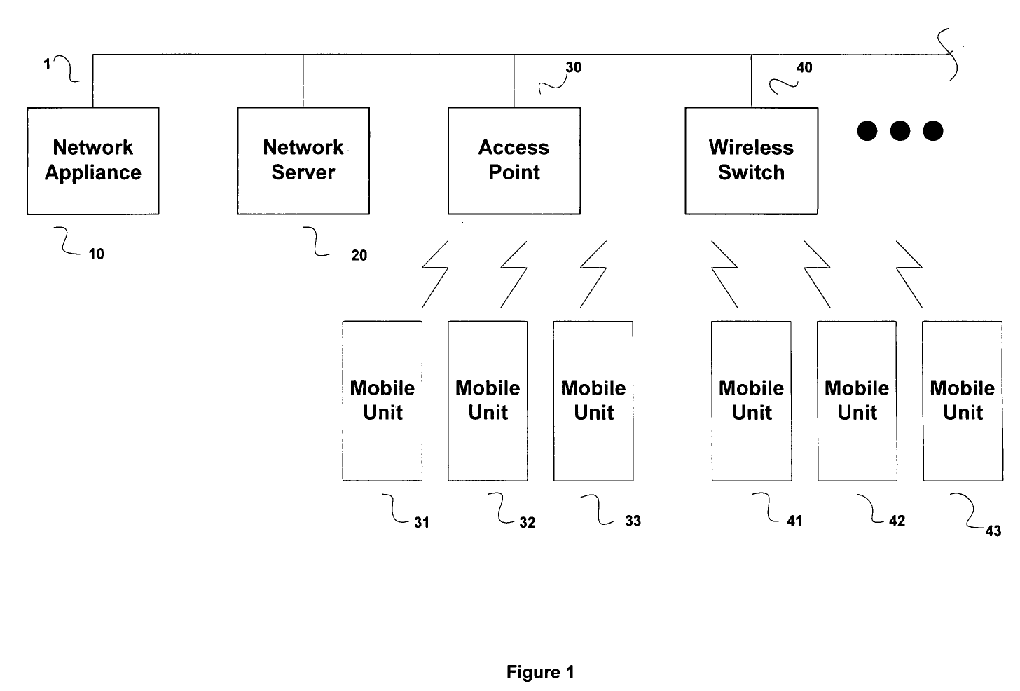

The present invention may be further understood with reference to the following description and the appended drawings, wherein like elements are provided with the same reference numerals. FIG. 1 shows an exemplary network 1 including a wireless network which may implement an exemplary embodiment of the present invention. The network 1 includes a network appliance 10, a network server 20, an access point 30 and a wireless switch 40. Each of these devices are shown as interconnected via a wired portion of the network 1. However, those of skill in the art will understand that these devices may also be wirelessly connected to the network 1. In addition, network 1 may also include any number of additional network components and/or devices (not shown).

FIG. 1 also shows mobile units 31-33 wirelessly connected to the network 1 via the access point 30. The mobile units 31-33 may be any type of computing or processor based device such as desktop or laptop computers, personal digital assistants, mobile phones, pagers, scanners, etc. The mobile units 31-33 and access point 30 may operate within any type of wireless networking environment, e.g., Wireless Local Area Network (“WLAN”), Wireless Wide Area Network (“WWAN”), etc. Communication between the mobile units 31-33 and the access point 30 may be accomplished using any wireless protocol such as IEEE 802.11, Bluetooth, etc. Similarly, mobile units 41-43 are wirelessly connected to the network 1 via the wireless switch 40. Those of skill in the art will understand that the network 1 is only exemplary and that the exemplary embodiment of the present invention may be implemented on any network which includes a wireless portion.

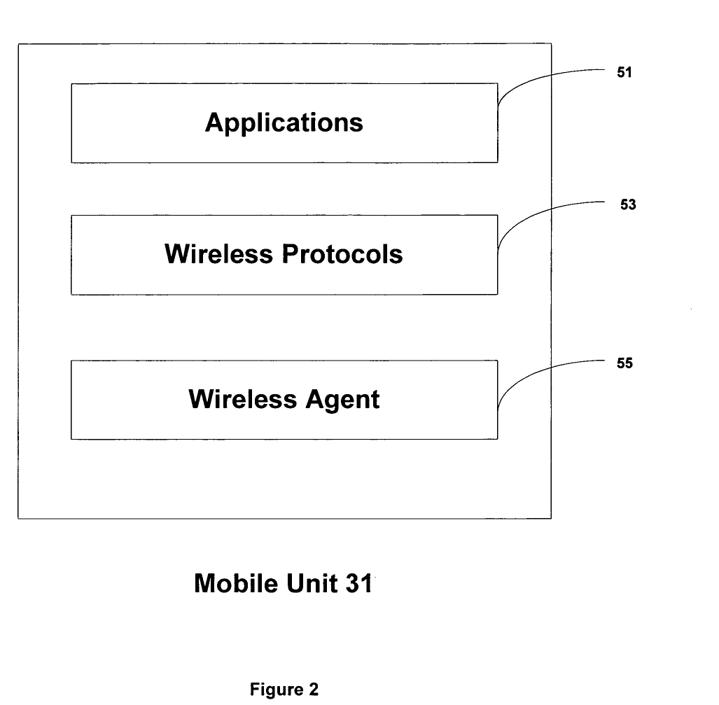

FIG. 2 shows an exemplary mobile unit 31 from the network 1 described with reference to FIG. 1. The mobile unit 31 includes various software components including applications 51, wireless protocols 53 and a wireless agent 55. Other software components may also be included in the mobile unit 31, e.g., an operating system. The applications 51 are those software components which allow the mobile unit 31 to perform the desired functionality, e.g., a check out application from the above described example. The wireless protocols 53 are the software components which allow the mobile unit 31 to communicate with the access point 30 or other mobile units.

The wireless agent 55 is a software component that includes functionality for the integrated wireless device and network management system according to the present invention. The wireless agent 55 resides on each of the mobile units in the network 1 (e.g., mobile unit 31) and collects information on the mobile unit. The wireless agent 55 may collect information or attributes such as battery level, available memory, receiving/transmission bandwidth, etc. Each of the mobile units 31-33 and 41-43 of the network 1 will include a separate wireless agent 55 to collect such information on the individual mobile unit. Throughout this description the term attribute may be used to refer to the identity of the collected information and/or the value of the collected information. Thus, the battery level attribute may refer to the attribute which measures the level of a battery in a device, but it may also refer to the actualvalue of the attribute, e.g., 95%.

While the exemplary embodiment of the present invention is described with reference to the wireless agent 55 collecting and transmitting the attribute information, the present invention is not limited to using a wireless agent to collect and transmit attributes. The present invention is aimed at the use of the attributes after they have been collected and thus, is not directly concerned with the mechanism for collection.

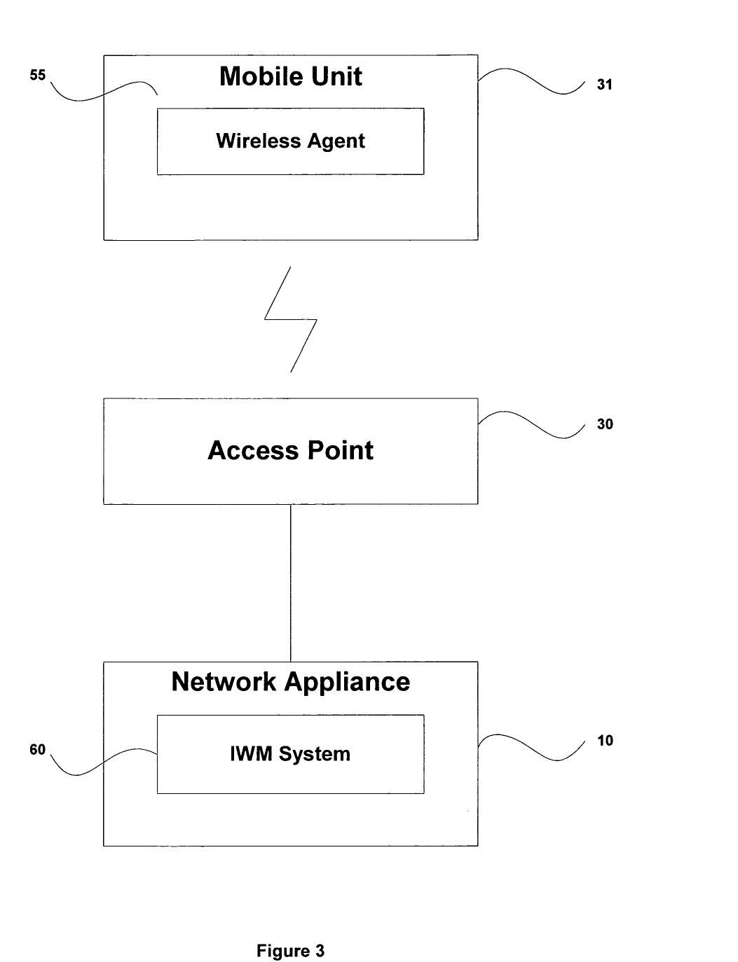

FIG. 3 shows an exemplary communication path between network devices. In this example the communication path is between the mobile unit 31 the access point 30 and the network appliance 10. The network appliance 10 is shown as including an Integrated Wireless Management (“IWM”) system 60. The IWM system 60 is the mechanism which collects the attributes which are transmitted by the mobile units 31-33 and 41-43. In this example, the information that is collected by the wireless agent 55 is communicated to the IWM system 60 on the network appliance 10.

For the other devices that are part of the wireless portion of the network 1, e.g., the access point 30 and wireless switch 40, the IWM system 60 may discover these devices based on their support of protocols such as the wireless network management protocol (“WNMP”), extensible markup language (“XML”), simple network management protocol (“SNMP”), etc. The IWM system 60 may query these devices through the object definitions such as standard Management Information Base (“MIBs”) object definitions as defined by protocol Request for Comments (“RFCs”) or other user defined object definitions as defined, for example, in an enterprise MIB. Thus, the IWM system 60 may also collect include information and attributes for these and other network devices to give a system administrator a full view of the entire network. Again, the present invention is not directed to the collection of the attributes so any manner of collecting attributes suffices for the present invention.

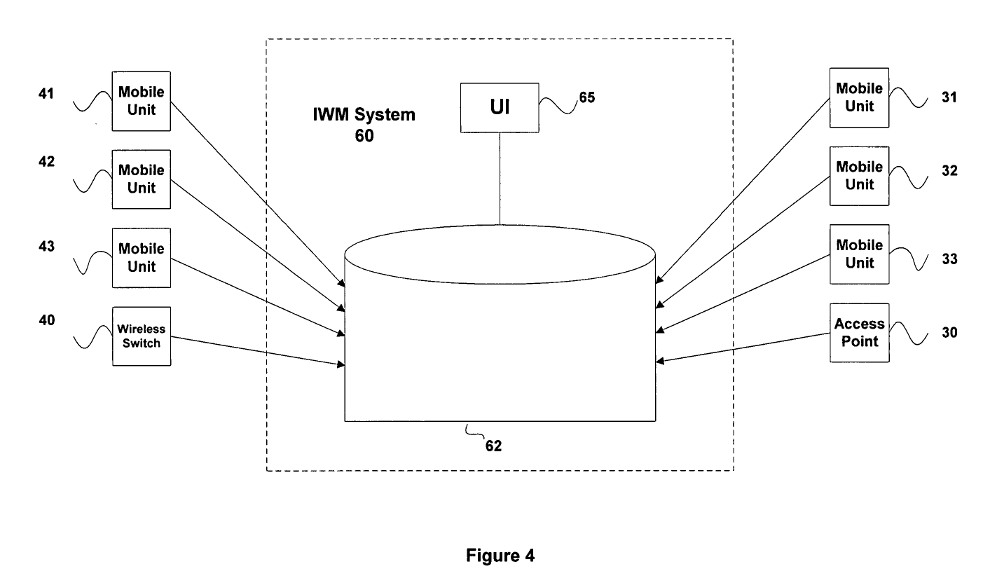

FIG. 4 shows an exemplary system diagram which shows the various components of the exemplary embodiment of the present invention. The IWM system 60 receives all the attribute information from a series of network devices, for example, access point 30, mobile units 31-33, wireless switch 40 and mobile units 41-43. The IWM system 60 stores the attribute information in a central location 62 so that a system administrator may interact with the IWM system 60.

The network appliance 10 may include outputs for a display device, a printer, etc. and inputs to receive commands from a keyboard, a mouse, etc. The system administrator may view the network information, e.g., the attributes, on a display connected to the network appliance 10 and interact with the IWM system 60 using the attached keyboard. Those of skill in the art will understand that the user interface 65 may take other forms. For example, the network appliance may include an interface to which a computing device is attached and the attached computing device along with its peripheral device may be used as the user interface 65.

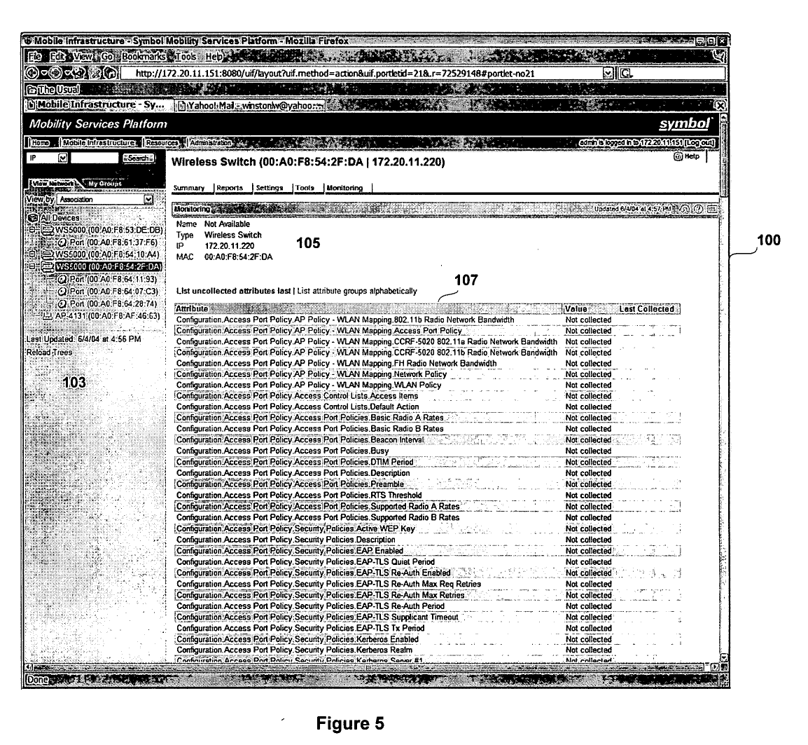

FIG. 5 shows a first exemplary user interface display screen 100 to display attributes collected by the IWM system 60. The display screen 100 includes a tree portion 103 which displays network assets in a tree form. In this exemplary view, the system administrator has selected to view the assets by a particular association which shows three wireless switches (WS5000) and an access point (AP-4131). It should be noted that for this and all the exemplary displays, the network and the network devices are not the network 1 described with reference to FIG. 1.

The system administrator may select one of the network devices from the tree to display further information. In this example, the wireless switch (WS5000 (00:A0:F8:54:2F:DA)) is selected as shown by the highlighting in the tree portion 103. The display screen 100 further includes an information portion 105 which provides general information on the device as shown in FIG. 5.

Finally, the display screen also includes an attribute portion 107 which displays the attributes which are collected by the IWM system 60 for this wireless switch. Additional attributes may be displayed by scrolling down through the attribute portion 107. In this example, no actual values for the attributes are displayed. However, during runtime, the attribute portion will display the value for each collected attribute and the time when the attribute was last collected.

Similar screens may be displayed for other devices on the network, e.g., mobile units, access points, etc. The attribute list may be different for the various devices because of the different functions they perform in the network, but the screen format may be the same to present a uniform display for all devices to the system administrator. The format of the display screen 100 is only exemplary and other formats to display the collected attributes may also be used.

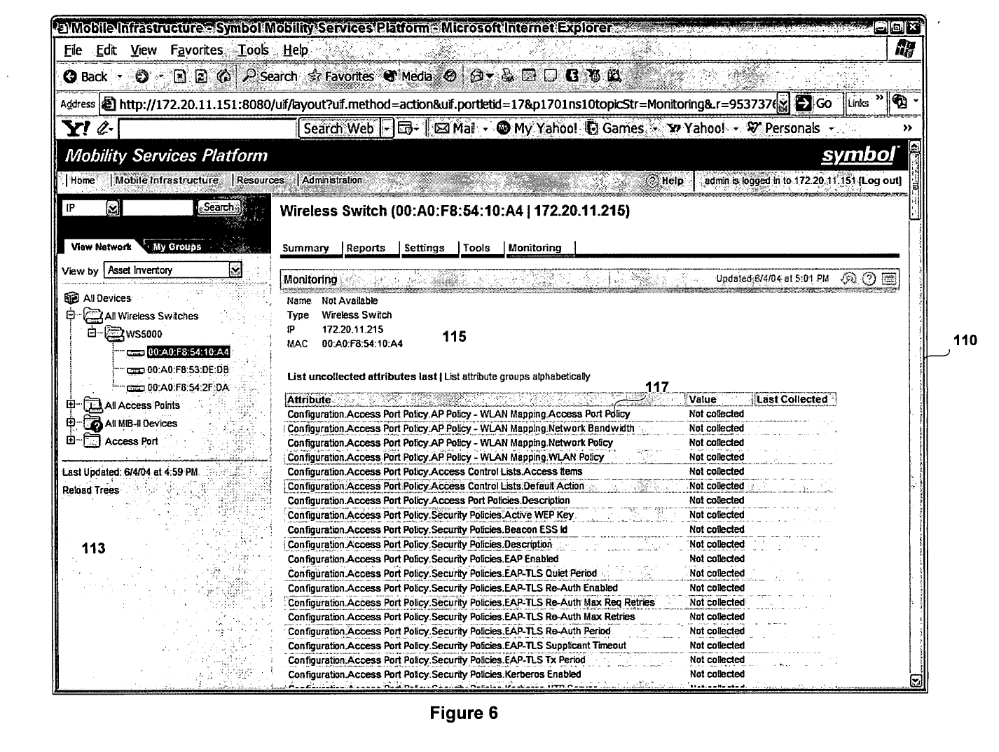

FIG. 6 shows a second exemplary user interface display screen 110 to display attributes collected by the IWM system 60. The display screen 110 also includes a tree portion 113 which displays network assets in a tree form. In this exemplary view, the system administrator has selected to view the assets by inventory. The general categories of devices include wireless switches, access points, MIB-II devices and access ports. The system administrator has expanded the view to show the wireless switches and has selected a particular wireless switch (00:A0:F8:54:10:A4) to display additional information for as shown by the highlighting.

The display screen 110 further includes an information portion 115 which provides general information on the device as shown in FIG. 6. The display screen 110 also includes an attribute portion 117 which displays the attributes which are collected by the IWM system 60 for the selected wireless switch, including the attribute value and the time when the attribute was last collected.

In addition to viewing the attributes, the exemplary embodiment of the present invention allows the system administrator to group devices and attributes for the purpose of monitoring the network. The monitored attributes may include attributes such as the number of scans a mobile unit has performed, the battery life, available memory, loaded software, serial numbers, CRC errors, average throughput, etc. Those of skill in the art will understand that these attributes are only exemplary and there may be hundreds of different attributes which may be monitored for the network devices, the mobile units and/or the general operation of the network.

The system administrator may create groups based on any of these monitored attributes or combinations thereof. The groups may be static groups or dynamic groups. Static groups are groups for which membership is static, i.e., the set of members does not change. If the system administrator desires to add new members to this group, the system administrator will have to re-define the group to include the new members because after a static group is defined the membership is closed.

A dynamic group is a group where the members may change based on the monitored attributes. As the monitored attributes change for the various devices, the group membership may change to include additional devices or exclude devices which previously qualified for the group. For example, a group may be based on battery level. A policy may be set that states that all mobile units that have a battery level less than a required value become part of the group for reporting to the system administrator. In a further example, a group may be defined as those mobile devices that have been re-booted three or more times in a day and have performed less than thirty scans. Thus, each day may include a different set of devices which qualify for this group. Therefore, since the group membership change in these example, the group is a dynamic group. In addition, as new devices are added to the network, these devices may also become members of the dynamic groups.

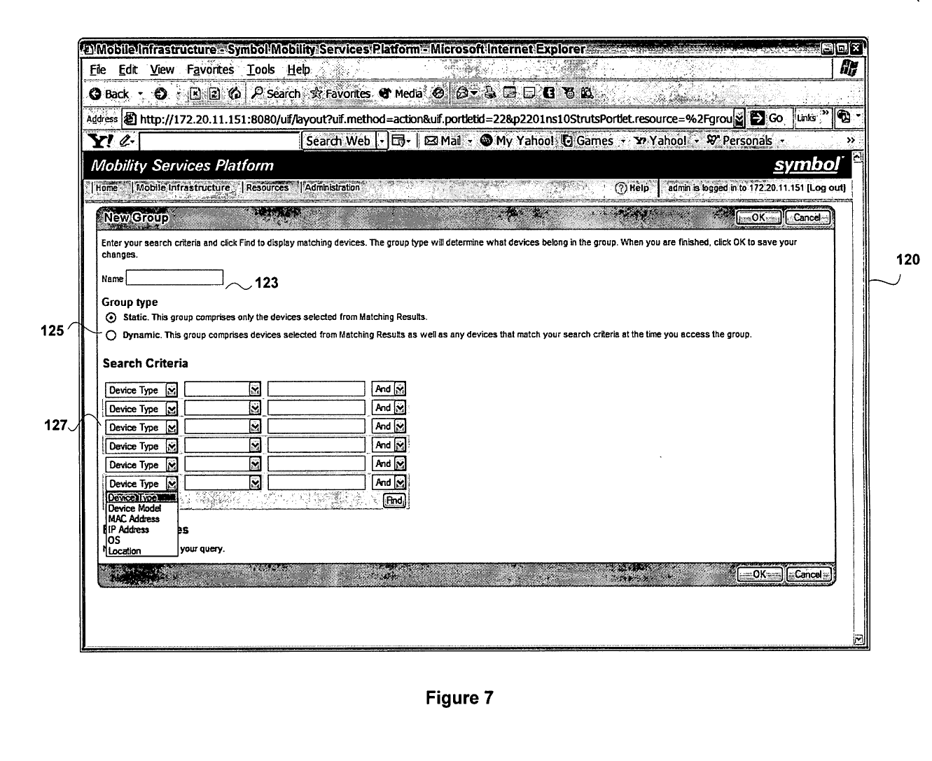

FIG. 7 shows a third exemplary user interface display screen 120 which a system administrator may use to create a group. A group may include any device or set of devices that the system administrator desires to monitor and/or control. The display screen 120 includes a naming portion 123 for the system administrator to name the group that is being created. The system administrator may also designate whether the group is going to be a static group or a dynamic group in the group type portion 125. As shown in FIG. 7, the group type portion 125 states that the static group comprises only the devices selected from Matching Results, i.e., the fixed members of the static group, while the dynamic group comprises devices that match the group criteria.

In the search criteria section 127, the system administrator may enter the search criteria for the group which is being created. As shown in this example, there may be drop down menus which the system administrator can use to define the groups. In the exemplary drop down menu shown in FIG. 7, the system administrator may select a search parameter which includes device type, device model, MAC address, IP address, Operating System (“OS”) and Location. Since this exemplary display screen 120 shows that the system administrator selected a static group, the exemplary search criteria will be used to define a set (constant) number of members. Again, these are only exemplary search criteria.

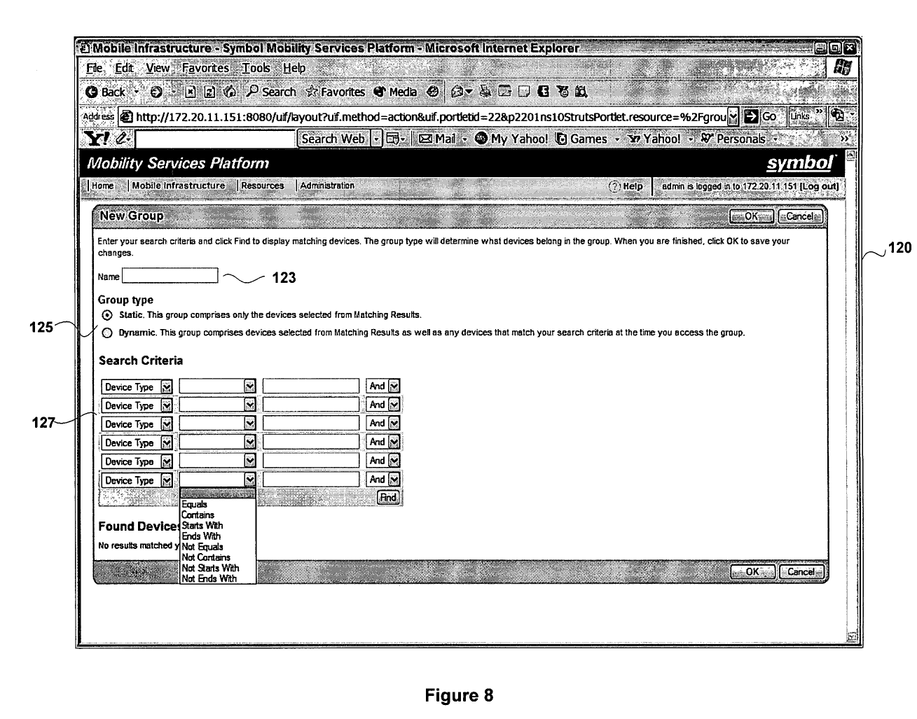

FIG. 8 shows an alternate view of the third exemplary user interface display screen 120 which a system administrator may use to create a group. The view of display screen 120 in FIG. 8 has all the same portions as the display screen 120 shown in FIG. 7, e.g., naming portion 123, group type portion 125 and search criteria portion 127. However, in this exemplary view, a different drop down menu is shown in the search criteria portion 127 which shows examples of search criteria parameters, e.g., equals, contains, starts with, ends with, not equals, not contains, not starts with, and not ends with.

Thus, a system administrator may select various search criteria using the display screen to select a group. As shown in FIGS. 7 and 8, the search criteria may include multiple parameters which can be combined using boolean operators, e.g, AND, OR, NOT, etc. The combination of various search parameters using the boolean operators provides for progressive filtering in the definition of groups.

The following will provide some examples of search criteria. These examples are not comprehensive because the permutations of search criteria a system administrator may use are virtually limitless depending on factors such as the number and type of devices and the number of monitored attributes. In a first example, the system administrator may select a static group which includes a device type which equals a certain device type. This may be accomplished by filling in the first field of the search criteria portion with “Device Type,” the second field with “Equals” and the third field with the name of the device type. The system administrator may further narrow this group by selecting the AND operator and including a second search criteria comprising a selected location. This may be accomplished by filling in the first field of the search criteria with “Location,” the second field with “Equals” and the third field with the name of the location.

In a second example, the system administrator may select a dynamic group in the group type portion 125 of the display 120. The search parameters may be different for a dynamic group. For example, the first drop down menu which is shown may include a list of the dynamic parameters which the system administrator may select. For example, the system administrator may decide to create a dynamic group for all devices whose battery level is less than a particular level. In this example, the system administrator would fill in the first field of the search criteria with “Battery Level,” the second field with “Less Than” and the third field with the minimum desired battery level. The system administrator may further narrow this group by selecting the AND operator and including a second search criteria comprising a selected model of a device. This may be accomplished by filling in the first field of the search criteria with “Device Model,” the second field with “Equals” and the third field with the model number/name. Once a group definition includes a criteria which may change over time to either include additional members or exclude current members, the group becomes a dynamic group.

The above described examples showed various groups which may be defined by a system administrator. Other potential groups should become apparent to those of skill in the art based on the above examples. A system administrator may define groups for any number of reasons. The purpose of the groups is for monitoring and control of the wireless network. For example, in the second example above, the system administrator may have defined the group to provide an alarm when the battery level of any device goes below the defined threshold, so the system administrator can alert the user of the device to change to a different device within a predetermined time period. The system administrator may also use this type of group to identify such things as devices which consistently lose battery level, a defective batch of batteries, etc. In this manner, groups may be used for preventive maintenance of the network and to highlight problem devices. This type of monitoring may also be used to determine end user efficiency.

Another example is that the group may be defined for provisioning purposes. Provisioning refers to the applications or set of applications that should be contained on a wireless device and the configuration of the wireless device. It may be desired that each wireless device in a selected location have the same set of applications, including the same version. The system administrator may select a group that includes all the wireless devices in a selected location and monitor the applications and versions numbers on these devices. The system administrator may then print a report showing the devices, applications and version numbers to verify each device includes the same applications. The group may also be set up to alarm if any of the group does not have the desired applications. In this example, the system administrator may use such a report when a new application or version is downloaded to verify that it was successfully downloaded to each of the devices.

Furthermore, the system administrator may define groups for the purposes of troubleshooting the wireless network. For example, the system administrator may receive a report from a user of a wireless device that it is operating slowly. Initially, the system administrator may view the attributes for that single device to determine if the problem is at the device level. The system administrator may then define a new group which includes all the wireless devices in the same location to determine if these devices are experiencing the same problem. The system administrator may then decide to define a new group which expands the devices the system administrator is currently viewing to include access points and wireless switches in the area to determine if the problem is being caused at the network level. The system administrator may continue to define new groups in order to expand and/or narrow the focus of the devices which are being viewed in order to troubleshoot the problem.

Thus, groups may be permanent groups defined and monitored on a regular basis or transient groups which are created for a specific purpose, e.g., troubleshooting. The transient groups may be discarded after their purpose has been accomplished. The system administrator may also set policies for the groups. The policies may include the collection conditions for the groups. For example, for the devices which are part of the battery level example, e.g., all wireless devices, the system administrator may set a policy where the attribute, e.g., battery level, is monitored continuously, e.g., every five (5) minutes. Whereas, in the provisioning example, the policy may be that the attribute is only monitored when there is a software change on the devices defined in the group.

It should be clear that devices may belong to any number of groups based on the definition of the particular group. Thus, a wireless switch may be included in multiple groups because the parameters of the wireless switch match the parameters of all of these multiple groups. Furthermore, for the dynamic groups, the group membership may be dynamic based on the defined criteria for membership in the group.

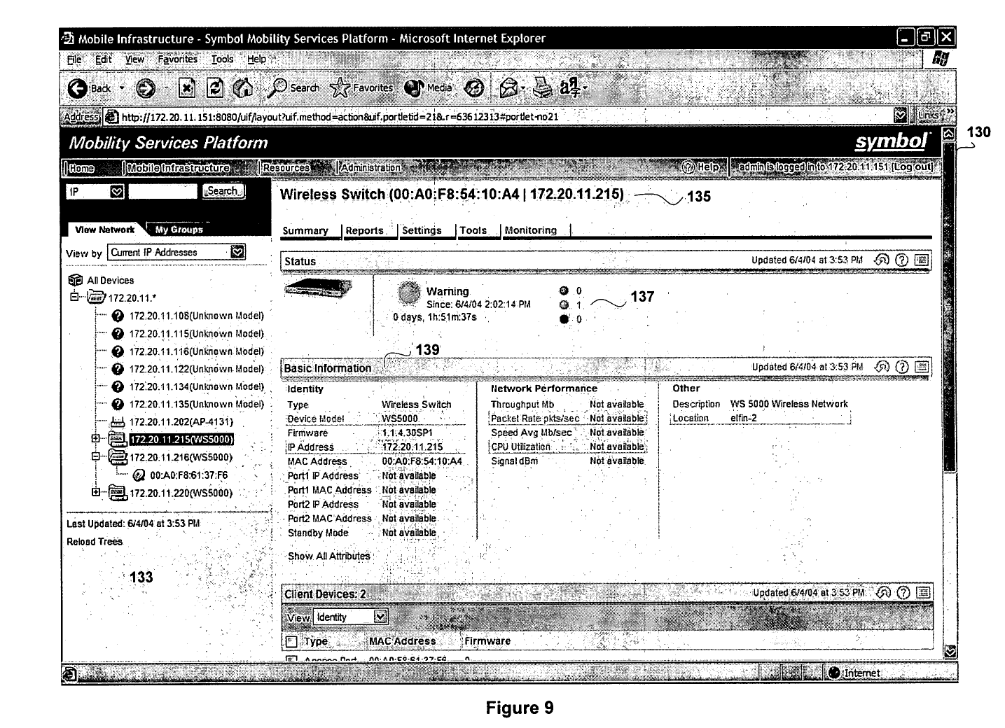

FIG. 9 shows a fourth exemplary display screen 130 which shows a display for a defined group. In this example, the display screen 130 includes a tree portion 133 which displays the members of the defined group in a tree format. This particular example group was defined as all devices within a range of IP addresses, e.g., those devices which have IP addresses starting with 172.20.11.*. As shown, all the devices which belong to the group are displayed in a hierarchical fashion in the tree portion 133. In this example, the hierarchy is based on the IP address starting from the lowest (172.20.11.108) through the highest (172.20.11.220). The hierarchy includes the ability to expand on certain devices to display additional information as shown in the example for the wireless switch having the IP address 172.20.11.216.

In addition, the system administrator may select a particular device for which to view additional information. This selection may be manual based on a selection by the system administrator or may be automatic based on a warning or alarm for the device. In the example of FIG. 9, additional information is shown for the wireless switch 172.20.11.215 as indicated by the highlighting of this device in the hierarchical tree portion 133.

The display screen 130 includes an identification portion 135 which shows the identity of the device for which additional information is displayed. The display screen 130 also includes a status portion 137 which shows the current status of the device. In this example, the particular device has a warning since a particular date and for a length of time as displayed in the status portion 137. Thus, this device may have been displayed because there was a warning associated with it. The warning may have been defined by the system administrator for the group. For example, the group may be the defined range of IP addresses, but the system administrator may defined an alarm criteria which included certain port statistics for any wireless switches in this IP address range. This particular wireless switch may have met the criteria and therefore a warning has been given for the wireless switch.

The status portion 137 may include different levels of warnings. While the display screen 130 is shown in grey scale, the system administrator may define three levels of warnings, green, yellow and red. The status portion 137 may indicate the warning level using the various color codes. If an individual device or portion of the network has a certain number of warnings in a particular time period or an absolute number of warnings, this data may be used for failure prediction.

The display screen 130 may also include an information section 139 which displays the various monitored attributes for the selected device. Examples of the monitored attributes include the identity of the device and the network performance of the device. The information that is displayed and/or the organization of the displayed information may depend on the purpose of the display. For example, if there is a warning for the device, the attribute which is causing the warning may be the first or in the first group of displayed information.

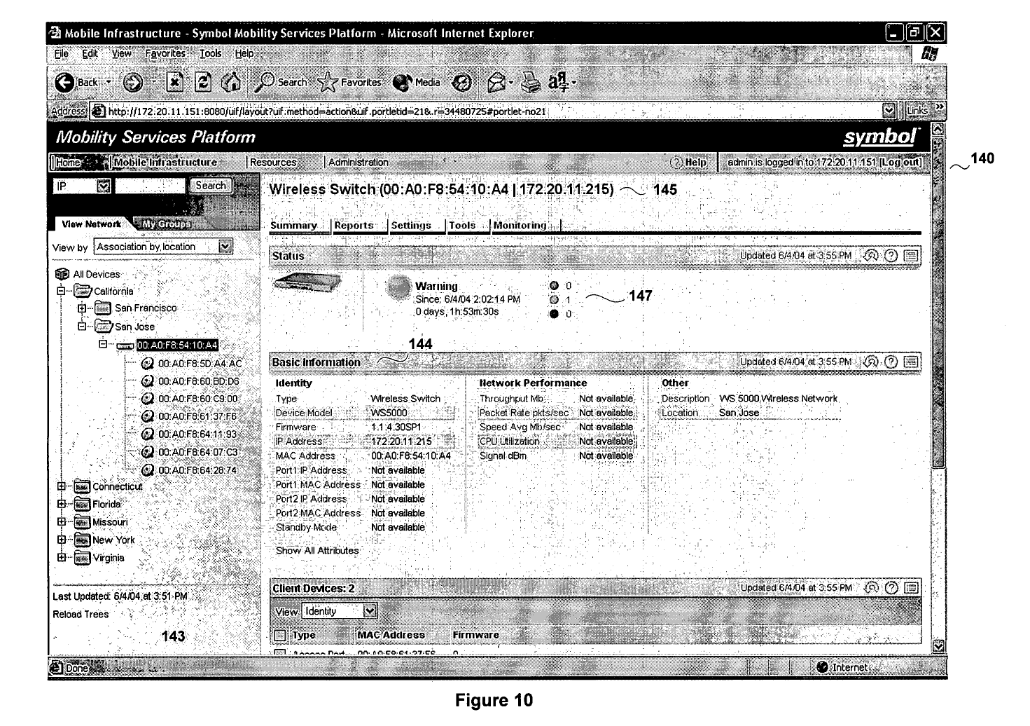

FIG. 10 shows a fifth exemplary display screen 140 which shows a display for a defined group. In this example, the tree portion 143 shows that the group is defined by location by state and city. Thus, the devices are split into groups for the various states in which they are deployed, e.g., California, Connecticut, Florida, etc. Within the states, as shown by the expanded view of California, the devices are further associated with the city in which they are deployed, e.g., San Francisco, San Jose. The split of devices by state and then city shows an example of progressive filtering in a group definition. Furthermore, it shows how the trees may be automatically generated based on the group membership using the progressive filtering.

As shown in the previous example, the display screen 140 may also include an identification portion 145, a status portion 147 and an information section 149 to provide additional information for the individual devices which are members of the group.

Those of skill in the art will understand that the above described display screens are only exemplary and that the user interface 65 may include any number of display screens for use by a system administrator. The content of these additional screens may depend on the functionality that is being performed by the system administrator.

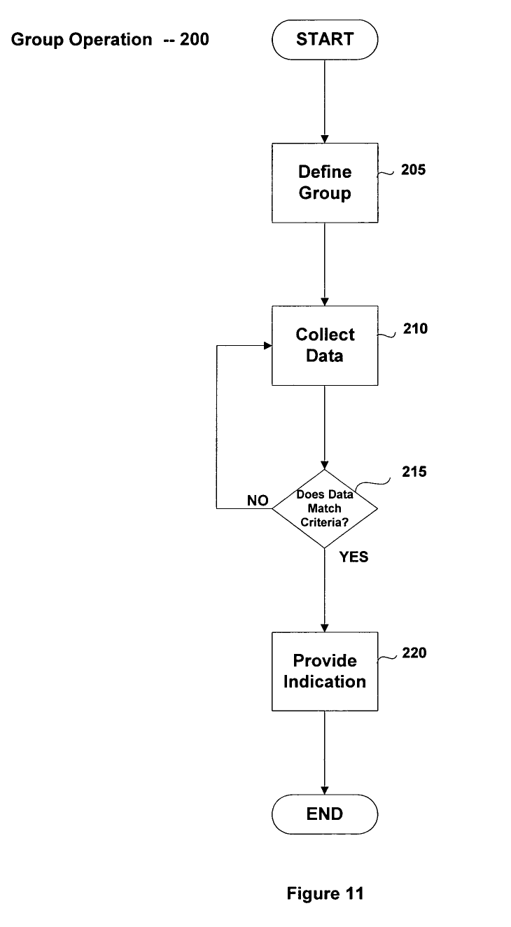

FIG. 11 shows an exemplary process 200 for grouping operations. In step 205, the system administrator will define the group as described above. Several examples of group definitions have been provided above. The first type of examples included specific parameter examples for the group definitions. The second type of examples provided desired functionality from the group. The parameter definitions for these type of groups will be based on the desired functionality se examples included both group definitions and desired functionality.

The system will then collect data in step 210. As described above, part of the group definition may be policies on the collection of various information. Thus, information for different groups may be collected at different time intervals. Furthermore, the group definition may include criteria for being included as a member in the group. Thus, as the data is collected various devices may qualify or be disqualified for membership in these dynamic groups.

The process then continues to step 215 where it is determined whether the collected data match a specific criteria which has been defined by the system administrator. If the data does not match the criteria, the system continues to collect data.

If the data matches a defined criteria, the system provides an indication in step 220. The indication of step 220 may be provided in any number of manners. For example, it may be in the form of a warning that is displayed to the system administrator, a message that is sent via electronic mail or pager to the system administrator, a message that is sent to a user of the device, etc. Additional examples of indications may be actual control actions that are automatically taken by the system. For example, if a specific criteria is met, the system may be instructed to shut down a portion of the wireless network because it is in a failure condition. Another example of an indication, may be a command by the system to collect additional data based on the type of information that has already been collected.

It should be noted that the data collection step 210 is a continuous process, i.e., the system continues to collect data from the network devices regardless of whether there are policy or criteria triggered by the attributes. Thus, the process 200 does not end while the system is in operation, data is continuously collected by the system and the collected data is compared to the defined criteria. There may be specific reasons why a particular piece of data is not collected such as a change in the data collection profile or the data collection profile is unassigned by the system administrator. However, in general, data collection is a continuous process.

As can be seen from the above description, the present invention allows a system administrator to define multiple organizational systems for the network. For example, the various static and dynamic groups. The groups may be exhaustive, e.g., all network devices, exclusive, e.g., each device is in only one category, both or neither. The exemplary embodiment provides for a hierarchical organization of the groups, but other organizations such as lists or flat displays based on the groupings may also be used.

The different types of groups and arrangements may facilitate different understandings of the network which it is representing. For example, a group organized around physical location may help the system administrator find the devices for maintenance, replacement, installation, etc. In contrast, a group organized by network association may facilitate tracking of network performance, tracking data paths from a mobile device to a server, etc.

In addition, as shown above in some of the examples, groups may be based on quantitative data such as battery level, etc. However, they may also be based on discrete values such as location (e.g., San Jose) or on event data such as failure to contact a device, new hardware detected, user log-in, etc.

The present invention has been described with the reference to the above exemplary embodiments. One skilled in the art would understand that the present invention may also be successfully implemented if modified. Accordingly, various modifications and changes may be made to the embodiments without departing from the broadest spirit and scope of the present invention as set forth in the claims that follow. The specification and drawings, accordingly, should be regarded in an illustrative rather than restrictive sense.

What is claimed is:

1. A method, comprising the steps of:
receiving attributes from a plurality of network devices, the attributes corresponding to information about each of the plurality of devices;
storing the received attributes;
defining a group of devices, the group definition including one of the received attributes; and
organizing the devices based on the group definition.

2. The method of claim 1, further comprising the step of:
displaying the devices which are members of the group.

3. The method of claim 2, wherein the display includes a set of attributes corresponding to each of the devices.

4. The method of claim 1, wherein the organizing step includes:
arranging the devices into one of a hierarchical structure and a list based on the group definition.

5. The method of claim 4, further comprising the step of:
displaying the one of the hierarchical structure and the list.

6. The method of claim 1, wherein the network devices include one of a wireless mobile device, a wireless switch and an access point.

7. The method of claim 1, wherein the group has a fixed membership.

8. The method of claim 1, wherein the group has a dynamic membership, the dynamic membership being based on a variable received attribute.

9. The method of claim 1, further comprising the step of:
providing an indication to a user when one of the received attributes meets a threshold defined by the user.

10. A system, comprising:
a receiving element configured to receive attributes from a plurality of network devices;
a database configured to store the received attributes;
an input element configured to receive a group definition from a user, the group definition including one of the received attributes;
an organizational element configured to organize the network devices into a group based on the group definition.

11. The system of claim 10, wherein the input element includes a graphical user input for the user to enter the group definition.

12. The system of claim 10, further comprising:
an output element configured to output information corresponding to the network devices which are members of the group to an output device.

13. The system of claim 12, wherein the output device is one of a display device and a printer.

14. The system of claim 12, wherein the output element configures the information in one of a hierarchical arrangement and a list arrangement.

15. The system of claim 12, wherein the output element configures the information for each network device that is a member of the group to include a plurality of the received attributes.

16. The system of claim 10, wherein the receiving element receives the attributes for a wireless mobile device from a wireless agent on the wireless mobile device.

17. The system of claim 10, further comprising:
a discovery element configured to discover network devices based on the network devices support of protocols.

18. The system of claim 17, wherein the protocols include a wireless network management protocol, an extensible markup language and a simple network management protocol.

19. A network appliance, comprising:
a data collection element configured to collect data from a plurality of network devices, the data including attributes corresponding to each of the network devices;
a storage element configured to store the collected data;
an input element configured to receive a group definition from a user, the group definition including at least one of the attributes; and
an organizational element configured to organize the collected data based on the group definition.

20. The network appliance of claim 19, further comprising:
an output element configured to display the collected data based on the group definition.
